(19) United States
(12) Patent Application Publication
(10) Pub. No.: US 2007/0056299 A1
(43) Pub. Date: Mar. 15, 2007

(54) Modified thermostatic control for enhanced air quality

(76) Inventor: Matthew C. Shankweiler, Plymouth, MN (US)

Correspondence Address: GLEN E. SCHUMANN;C/O MOSS & BARNETT, 90 SOUTH SEVENTH STREET, 4800 WELLS FARGO CENTER, MINNEAPOLIS, MN, 55402-4129, US

(21) Appl. No.: 11/227,455

(22) Filed: Sep. 15, 2005

(51) Int. Cl. G05D 23/32

(52) U.S. Cl. 62/157

(57) ABSTRACT

A method and system for supplementing a conventional temperature-controlled on-cycle for an HVAC unit with a complementary timer-controlled circuit that produces a programmed series of supplemental on-cycles of short duration for the HVAC unit during the conventional off-cycle is provided according to the invention. The purpose of such supplemental on-cycles for the HVAC unit is not to cool or heat the air, but instead to introduce some fresh incoming air into the interior space that has been conditioned to enhance the comfort quality characteristics of the interior air (e.g., humidity level, freshness) to reduce the stagnant quality of the air. The short duration of these supplemental on-cycles should ensure that the HVAC system does not run long enough to cool or heat the interior air beyond the desired temperature set point. Such supplemental burst cycles may be programmed in series through the thermostatic control, or manually produced by the user on command.

### FIELD OF THE INVENTION

This invention relates generally to the heating, ventilation, and air conditioning (“HVAC”) of a room space, and more specifically to the modified control of such an HVAC unit in order to freshen the room air with bursts of fresh air to produce an improved air quality for increased comfort.

### BACKGROUND OF THE INVENTION

HVAC systems are commonly used to control the temperature of the interior space of a building or other structure. The furnace portion will provide heated air to the space when the room temperature falls below a desired temperature level. Similarly, the air conditioner portion will provide cooled air to the space when the room temperature rises above the desired temperature level.

Temperature, however, is only one aspect of air quality or air comfort. An added benefit of the air conditioner is that it will reduce the moisture level contained in the air, and therefore provides a partial dehumidification function, which improves the comfort level of the air. By the same token, furnaces located in northern climates where air can become overly dry during winter months sometimes have humidifier units operatively attached to them to introduce moisture into the heated air produced by the furnace to provide partial humidification of the air.

A thermostat is commonly used to control the operation of the HVAC system. Thus, for the air conditioner cycle, the thermostat is set or programmed by the user for a pre-selected temperature set point—e.g., 72° F. When the thermostat senses that the temperature in the surrounding air has risen above 72° F., for example 73° F., the thermostat will turn the air conditioner on to run and introduce cooled air into the surrounding air until the sensed room temperature falls back below 72° F. The duration of this “on-cycle,” and the duration of the subsequent “off cycle” until the room temperature rises once again to 73° F. to cause the thermostat to turn on the air conditioner once again, are impacted by a host of factors including the temperature outdoors, the relative humidity level of the ambient air, whether the day is sunny or cloudy, whether it is daytime or nighttime, etc. For the furnace cycle, the thermostat will start the furnace “on-cycle” when the sensed room temperature falls below 72° F, and the furnace will run until the sensed temperature in the surrounding interior space reaches 72° F. once again. An off-cycle will then commence and last until the sensed temperature falls below 72° F. again.

The primary function of such a thermostat, therefore, is to control the commencement and duration of the on-cycle and off-cycle of the air conditioner or furnace relative to the temperature sensed within the room. This ensures that the room does not become too hot or too cold. Besides contributing to the comfort level of the room, the thermostat also ensures that the air conditioner or furnace is only operated when needed, thereby conserving the energy (e.g., natural gas, oil, electricity) used to operate the HVAC unit.

Efforts have been made within the HVAC industry to improve thermostatic controls in order to operate furnaces or air conditioners on an even more energy-efficient basis. Thus, U.S. Pat. No. 4,509,585 issued to George Carney et al. discloses an energy management control system that interrupts the supply of energy to heating or cooling equipment in response to thermostat demand for intermittent periods during high-demand intervals in order to save energy consumption. The system times the duration of such demand intervals and controls the intermittent interruption of the heating or cooling equipment to optimize the energy savings.

U.S. Pat. No. 6,179,213 issued to Gilino et al. covers a special-purpose, interactive programmable computer for a thermal/ventilation system that automatically operates the system at specified times and over specified timing cycles. In this manner, the operation of an HVAC system can be altered at the programmed time points to override the normal thermostat control of the HVAC unit. For example, during the day when no one is home, the furnace or air conditioner could be run for shorter durations to maintain the present temperature of the room, since such temperature control is unnecessary. This approach departs from conventional programmable thermostats available on the market that allow the user to program different set point temperatures for different times of the day.

U.S. Pat. No. 4,944,453 issued to Ronzani is directed to a heating system with dual timer controls for enabling the user to control the duration of the HVAC on-cycle and off-cycle. U.S. Pat. No. 6,662,866 issued to Heath provides an energy conservation moderating system that modifies the “on” signal emitted by a thermostat to an “off” signal for a predetermined time period in order to reduce the total on-time of the HVAC unit. By contrast, U.S. Pat. No. 4,671,457 issued to Berkhof covers an improved thermostat control device in which the user pre-selects a desired on-cycle time period, while the thermostat controls the real on-cycle time duration in response to the sensed temperature in the room. The actual on-cycle time period is compared by the thermostat to the desired on-cycle time period, whereby the burner heat output of the HVAC system is automatically adjusted to bring the actual on-cycle period into line with the desired on-cycle period. The purpose for all of these modified thermostat controls systems, however, is to save energy costs associated with operating the HVAC unit.

Nevertheless, the comfort level of air is dependent upon more than just temperature. Excessive humidity within the air can cause air to feel sticky and stifling. This can be true even if the actual room temperature is at the desired temperature set point. This can be a particular problem within homes during the night when higher daytime temperatures have created a buildup of heat within the house which rises to the upper floor where bedrooms are typically located. This heat accumulation can cause the air to feel warm, compounded by enhanced humidity levels within the bedroom produced by the breathing by family members as they sleep. At the same time, the cooler outdoor temperatures of the night can cause the lower floor where the thermostat is often located to be cooler, thereby delaying the thermostatic-controlled commencement of the air conditioner on-cycle that would otherwise cool and dehumidify the upstairs air. The result is uncomfortable air on the upstairs level of the house. While some larger houses feature a separate air conditioner or air conditioning zone for the second floor to respond to the actual temperature of the upstairs floor, this option is impracticably expensive for most houses.

Efforts have been made within the HVAC industry to address this air discomfort issue. Thus, U.S. Pat. No. 6,695,218 issued to Fleckenstein discloses a comfort control system used in association with a thermostat in which predictive control is employed to operate the blower fan of the HVAC unit while the air conditioner is off based upon a series of computer-generated calculations. Moreover, an air-circulation enhancement system is taught by U.S. Pat. No. 5,582,233 issued to Noto whereby the blower fan in the HVAC unit remains on for approximately 2½ minutes after the air conditioner is shut off by the thermostat to transport any residual cooled air left in the HVAC plenum into the room space. The blower fan is then switched on for 1½ minutes and then off for 15 minutes with this cycle repeated throughout the thermostat-induced off-cycle for the air conditioner. See also U.S. Pat. No. 4,838,482 issued to Vogelzang. Similarly, U.S. Pat. No. 5,547,017 issued to Rudd discloses a control system that recycles the blower fan during the air conditioner off-cycle wherein the special fan cycle period is adjustable based upon a number of non-thermostat parameters such as room volume size and the number of occupants within the room.

While the thermostat control systems of these patents expand the use of the HVAC blower fan which normally would only operate while the air conditioner is on, they only partially solve the problem posed by stagnant air in a room. The blower fan can help to stir up and move the air contained within the room. This solution is similar in concept to operating a ceiling fan or a portable fan in the room—albeit, most HVAC systems circulate air through multiple rooms in a home. Nevertheless, the blower fan is moving the air that is already in the interior space, and does nothing to improve its overall quality such as reducing the humidity level in the air or freshening it with new air in the manner that an air conditioning cycle or air exchanger can do.

U.S. Pat. No. 6,843,068 issued to Wacker adopts a slightly more sophisticated approach by providing a thermostatic control system for an air conditioner in which the temperature set point of the thermostat is automatically adjusted in response to the humidity level of the room. Thus, if the sensors located in the room detect that the relative humidity of the room has risen above a pre-desired level, then the temperature set point of the thermostat will be reduced to cause the air conditioner to operate for a sufficient time period to remove the necessary amount of moisture from the air to reduce the humidity to its desired level, whereupon the temperature set point is returned to its original position to turn the air conditioner off. Wacker teaches that this modified thermostat control system can be programmed for different time zones of the day where the interior space of the building is occupied or unoccupied. In this manner, the special on-cycle of the air conditioner could be 20 minutes in duration when the space is occupied. When the space is unoccupied, this special air conditioner on-cycle could be much shorter in duration, since excessive humidity will not impact people who are not present. Wacker expressly teaches that frequent HVAC cycling can be perceived as causing discomfort to dwellers within the interior space, so longer air conditioner on-cycles on the order of 20 minutes should be used.

While the thermostat control system of Wacker may be useful for reducing high humidity levels within the air, prolonged air conditioning on-cycles can cause excessive cooling of the interior space. If the thermostat were to truncate the special air conditioner on-cycle when the actual temperature in the room reaches the original set point, then inadequate humidity reduction may result.

U.S. Pat. No. 4,725,001 issued to Daniel Camey, et al. discloses a thermostat control system that uses a different approach. First, the thermostat operates the air conditioner during a prolonged on-cycle to bring the room temperature to a desired level. Next, the thermostat cycles the air conditioner on and off over short intervals (e.g., 5-25-minute off-cycle; minimum 5-minute on-cycle) in order to maintain the room temperature at that present level. This special air conditioner short cycling is done in lieu of normal thermostatic control which would turn the air conditioner on when the room temperature exceeds the preset level, and turn it off once the room temperature returns to that present level. Instead, the special cycle time for the air conditioner will be adjusted automatically by the thermostat in response to the actual room temperature to prevent overcooling of the room.

U.S. Pat. Nos. 4,722,475 and 4,787,555 issued to Newell III et al. cover an environmental control system in which the air conditioning unit is operated in response to both the sensed room temperature and a timer circuit. Disclosed for use in buildings that house livestock, this system actuates the air conditioner during the separate timer cycle independently of the actual temperature sensed in the room. Operation of the air conditioning during the separate timer cycle is intended to provide a necessary degree of cooling to the animals who are often (e.g., chickens) confined in very small areas and therefore subject to overheating. In order to optimize the growth and health of the animals and compensate for their increase in body heat and other factors as the animals increase in size, maintenance of proper body temperatures is essential. The air conditioner operation can also trigger a much-needed ventilation apparatus for the animal barn.

Both the temperature-controlled and timer-controlled on-cycles for the air conditioner taught by Newell are used to cool air in the interior space. Because the two duty cycles may operate independently of each other and cause actuation of the air conditioner for the timer cycle right after the thermostat has ended the temperature-controlled cycle, this can lead to excessive cooling and a resulting waste of energy. Newell therefore provides a temperature sensor feed back loop in the thermostat control system which alters the timer cycle to shorten it going forward for successive timer on-cycles until the room temperature condition is corrected to allow the system to restore the original preset timer cycle.

While the circulation systems for human beings provide them greater adaptability to higher temperatures and humidity than circulation systems for chickens, such excessive temperature and humidity conditions can produce profoundly uncomfortable conditions for living or work. Therefore, being able to enhance the conventional temperature-controlled on-cycle for an air conditioner with a complementary timer-controlled circuit that produces a single or series of supplemental on-cycles of short duration for the air conditioner during the conventional off-cycle of the air conditioner would be very advantageous. The purpose of such supplemental on-cycles for the air conditioner is not to cool the air, but instead to dehumidify the air and introduce some fresh incoming air to the interior space to reduce the stagnant quality of the air.

### SUMMARY OF THE INVENTION

A method and system for supplementing a conventional temperature-controlled on-cycle for an HVAC unit with a complementary timer-controlled circuit that produces a programmed series of supplemental on-cycles of short duration for the HVAC unit during the conventional off-cycle is provided according to the invention. The purpose of such supplemental on-cycles for the HVAC unit is not to cool or heat the air, but instead to introduce some fresh incoming air into the interior space that has been conditioned to enhance the comfort quality characteristics of the interior air (e.g., humidity level, freshness) to reduce the stagnant quality of the air. The short duration of these supplemental on-cycles should ensure that the HVAC system does not run long enough to cool or heat the interior air beyond the desired temperature set point.

Alternatively or additionally, the thermostat control for regulating the conventional temperature-controlled on-cycle of the HVAC unit could be designed to permit a single supplemental on-cycle in response to a manual prompt by the user. This would provide an immediate on-command burst of fresh, conditioned air to the interior space.

A feed-back loop provided by a temperature sensor is used by the thermostat control to truncate any on-cycle in case the temperature of the interior space progresses more than an acceptable amount beyond the temperature preset. This ensures that the interior space does not become overcooled or overheated.

The thermostat control may also be programmed to customize the frequency and duration of these supplemental on-cycles for the HVAC system. This can take into account the specific characteristics of the volume of the interior space, heating or cooling capacity of the HVAC system, and the degree of insulation surrounding the interior space. Moreover, the programmed frequency and duration of the supplemental on-cycles can take into account ambient conditions, such as the outdoor temperature and relative humidity levels, and whether the sun is shining through the windows surrounding the interior space. The thermostat control may even be programmed for different times of the day or night to further customize the frequency and duration of these supplemental on-cycles to account for changing ambient conditions and whether the interior space is expected to be occupied or unoccupied. In particular, this programming feature can ensure that the supplemental on-cycles are available in the evening when freshening of the air and humidity reduction or increase are in greatest need.

### BRIEF DESCRIPTION OF THE DRAWINGS

In the accompanying drawings:

FIG. 1 is a block diagram of an illustrative system for controlling an air conditioner in accordance with the present invention.

FIG. 2 is a graph illustrating the control of the operation of the air conditioner unit in response to the temperature measured within the interior space.

FIG. 3 is a graph illustrating the control of the operation of the air conditioner unit in response to the temperature measured within the interior space coupled with time-dependent secondary burst cycles in accordance with the present invention.

FIG. 4 is a graph illustrating the air conditioner control system of FIG. 3 coupled with a delayed termination of the blower fan operation upon termination of the primary air conditioner on-cycle.

FIG. 5 is a graph illustrating another embodiment of the air conditioner control system of the present invention, including secondary on cycles and idle and burst cycles therefore that are modified in response to whether the interior space is expected to be occupied or unoccupied.

### DETAILED DESCRIPTION OF THE PREFERRED EMBODIMENT

Use of timer-controlled supplemental on-cycles of short duration for an air conditioning system during the conventional temperature-controlled off-cycle in order to freshen air in an interior space, reduce its humidity, and otherwise enhance its comfort quality is provided by the invention. Such supplemental on-cycles compliment the primary temperature-controlled on-cycle, and are regulated by a thermostat control system so that the supplemental on-cycle is truncated as needed to prevent the temperature of the room from falling more than an acceptable amount below the temperature preset. The thermostat control can be programmed to customize the availability of such supplemental on-cycles, and their frequency and duration to the times during the day and night when they are especially needed.

For purposes of the present invention, “building” means any house, apartment, condominium, hotel, office building, factory, shopping mall or retail establishment, restaurant, hospital, laboratory, arena or entertainment establishment, gym or fitness facility, museum, school or university, governmental office or other public facility, or other structure where people live, work, learn, play, or visit, and where maintenance of the temperature and comfort of the air therein is desirable.

For purposes of the present invention, “transportation vehicle” means any automobile, sport utility vehicle, truck, airplane, train, bus, or other mode of transportation.

In the context of the present invention, “interior space” means the air contained within a building or transportation vehicle to which people or domesticated animals come into contact. Such an interior space may consist of a single room or multiple communicating rooms.

For purposes of the present invention, “comfort”, when used in association with air, refers to the temperature, humidity, or freshness of such air.

As used in this application, “HVAC” means any heating, ventilation, or air conditioning equipment used to heat, cool, or ventilate the air contained within an interior space of a building or transportation vehicle.

For purposes of the present invention, “primary on-cycle” means a time period during which an HVAC system is operating in response to a temperature-controlled thermostatic system.

In the context of the present invention, “secondary on-cycle” means a time period during which an HVAC system is operating in response to a timer-controlled thermostatic system.

For purposes of this application, “off-cycle” means the time period during which the thermostatic control turns off the HVAC system in response to a preset temperature or time value.

An air conditioner unit shall be used as an exemplary HVAC system for purposes of this application, but it is important to appreciate that any other HVAC unit or associated equipment that can contribute to the comfort quality of air, such as a furnace, humidifier, dehumidifier, air exchanger, or ventilator, can be used as well within the scope of this invention. For example, furnaces often have humidifier units attached thereto which are operated while the furnace is running in order to introduce needed moisture into the heated air to be introduced to the interior space during drier, winter months. Moreover, HVAC systems incorporate a circulation or blower fan to propel the heated or cooled air through a duct system to the interior space by means of positive pressure while the HVAC is running. Such blower fans can provide at least a small amount of air circulation in an interior space to ameliorate the stagnant quality of the air. At the same time, an air exchanger or other ventilation system can be operatively attached to the HVAC system to introduce fresh outdoor air into the plenum for transport to the interior space, or otherwise ventilate it prior to its transit through the ducts to the interior space—all of which results in improvement of the comfort quality of the air within the interior space.

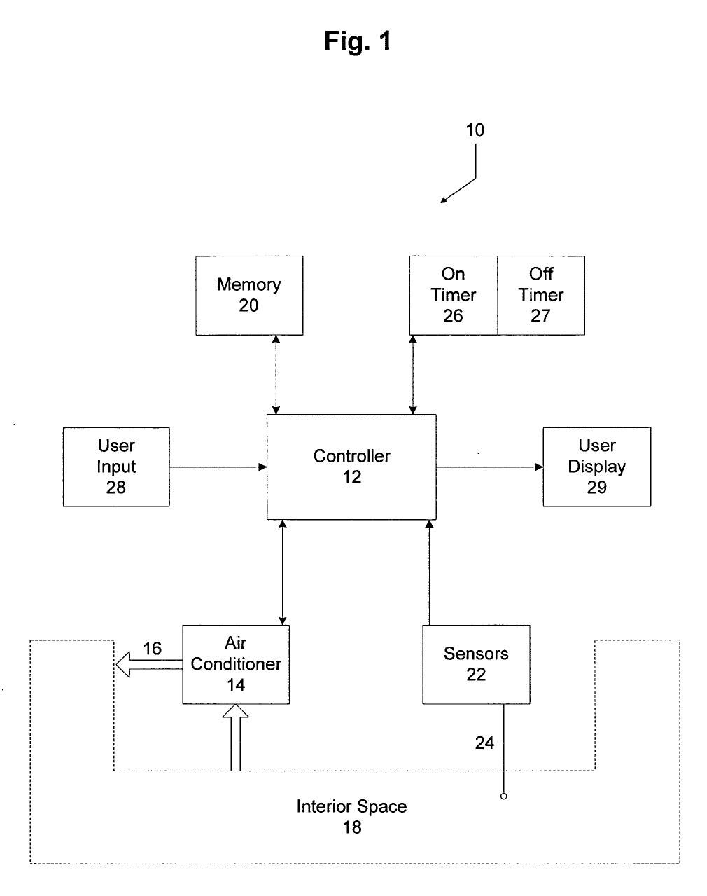

FIG. 1 is a block diagram of an illustrative system for controlling an air conditioner in accordance with the present invention. Control system 10 includes a controller 12 for regulating the operation of an air conditioner 14 used to cool the air 16 supplied to an interior space 18 of a building or transportation vehicle. The controller 12 is preferably a microprocessor that is controlled by software stored in memory 20. However, controller 12 may take the form of any suitable controller mechanism, depending upon the desired application.

One or more sensors 22 provide sensor signals to controller 12 characteristic of one or more environmental conditions of the interior space 18. One particular sensor is shown at 24, which will typically be a temperature sensor. Other sensors may include, but are not limited to, humidity sensors, gas sensors, etc. Sensor 24 will cause controller 12 to provide a control signal to air conditioner 14 to turn it on and off in order to regulate or maintain various preselected environmental conditions within the interior space 18, such as temperature, humidity, etc.

As discussed above, memory 20 may store a computer program that is executed by controller 12. Memory 20 may be, by way of example, Random Access Memory, Read-Only-Memory, Read/Writable Non-Volatile Memory, magnetic media, compact disk, or any other appropriate data storage medium. In one embodiment of this invention, memory 12 includes both Random Access Memory and Read/Writable Non-Volatile Memory.

Also operatively connected to controller 12 are on-timer 26 and off-timer 27. These timers will start and stop the secondary air conditioner on-cycles and off-cycles via the controller that provide bursts of air-conditioned air to the interior space, as discussed more fully herein.

In some embodiments of the present invention, user interface 28 is operatively connected to controller 12. The user may utilize the user interface 28 to enter or change set points, timer set points, schedules, and other control parameters, as will be discussed more fully herein. Such control parameters may include without limitation temperature set points, humidity set points, upper and lower temperature or humidity threshold values, times during the day or night when the interior space is expected to be occupied or unoccupied, etc. Some or all of these control parameters may be stored in memory 20, if desired.

A user display 29 may be operatively coupled to controller 12 to display pertinent information to the user. This information could include, by way of example, the actual temperature or humidity level sensed in the interior space 18 by sensor 24, time of the day, and/or the temperature or humidity set points or time schedules programmed into memory 20 by the user.

Table 1 shows the interior and exterior temperatures and on-cycle and off-cycle durations for a conventional air conditioning system used to service a house with a high insulative value located in Plymouth, Minn. on a typical August day. This was a relatively temperate Summer day. The thermostat set point for desired interior temperature was 72° F. The temperature of the interior space had been at 74° F., and the air conditioner on-cycle commencing at 9:47 a.m. represented the first on-cycle immediately following the initial on-cycle used to bring the interior temperature down to 72° F. The air temperature may still have been a little unstable, resulting in the temperature rising to 73° F. after only 12 minutes to cause the thermostat to commence that 9:47 on-cycle.

TABLE 1

| | | | On- | | | Out- |
|---|---|---|---|---|---|---|
| | Conditions | Time of | Cycle | Inside | Outside | side |
| Time of | in Interior | Previous | Dura- | Temp | Temp. | Humid- |
| Day | Space | Off-Cycle | tion | (° F.) | (° F.) | ity |
| 9:47 a.m. | RO; SN | 12 | 9.5 | 73 | 65 | 89 |
| 11:00 a.m. | RNO; SN | 63 | 8.5 | 73 | 65 | 89 |
| 12:12 a.m. | RNO; SN | 63 | 8.5 | 73 | 65 | 89 |
| 1:00 p.m. | RO; SP | 39 | 10 | 73 | 65 | 89 |
| 1:59 p.m. | RO; SP | 49 | 10.75 | 73 | 70 | 89 |
| 2:52 p.m. | RNO; SP | 42 | 9.75 | 73 | 74 | 89 |
| 3:37 p.m. | RO; SP | 35 | 9.75 | 73 | 75 | 88 |
| 4:44 p.m. | RNO; SN | 57 | 10 | 73 | 76 | 78 |
| 5:35 p.m. | RO; SN | 41 | 10 | 73 | 76 | 76 |
| 6:16 p.m. | RO; SN | 31 | 10 | 73 | 76 | 74 |
| Averages | | 43.2 | 9.7 | 73 | 70.7 | 85 |

Legend:
RO = Room Occupied
RNO = Room Not Occupied
SN = Sun Not Present
SP = Sun Present

As can be seen from this data, it pretty consistently took the air conditioner 9-10 minutes of on-cycle duty to reduce the temperature of the interior space by 1° F. to reach the desired 72° F. set point. In general, the on-cycle duration was slightly less during the morning hours when the outside temperature was lower. This on-cycle duration increased slightly in the afternoon hours when the outside temperature increased from 65° F. to 76° F. The decreasing relative humidity level throughout the day undoubtedly had some impact, as well.

More instructively, the off-cycle time for the air conditioner was greater (63 minutes) in the morning hours when the interior space was unoccupied and the sun was not present. Around 1:00 when the outside temperature remained at 65° F., but the interior space was occupied by one adult and the sun was present, this off-cycle duration dropped to 39 minutes, illustrating the increasing temperature inside the room, and consequent need for the air conditioning. This off-cycle duration increased slightly when the room became unoccupied once again (2:52 p.m.), even though the outside temperature continued to increase. It dropped greatly when the room became occupied again by one adult (3:37 p.m.), jumped with an unoccupied room and shady conditions at 4:44 p.m., but then dropped once again at the 5:35 p.m. and 6:16 p.m. time points when two adults and two children occupied the room. This data illustrates the significant impact of outside temperature, sun status, and room occupancy on the duration of the air conditioner off-cycle. Moreover, it does not depict operation of the air conditioner during the night hours when the off-cycle can be even longer due to lower outside temperatures and less heat load entering the house through radiant heat. At the same time, the heat load that has accumulated in the house throughout the daytime tends to rise to the upper level where the bedrooms commonly are located to create stagnant and often sweltering air quality. This leads directly to occupant discomfort, since the air conditioner primary cycle may only commence every hour or more due to the reduced heat load on the lower house level where the thermostat is located.

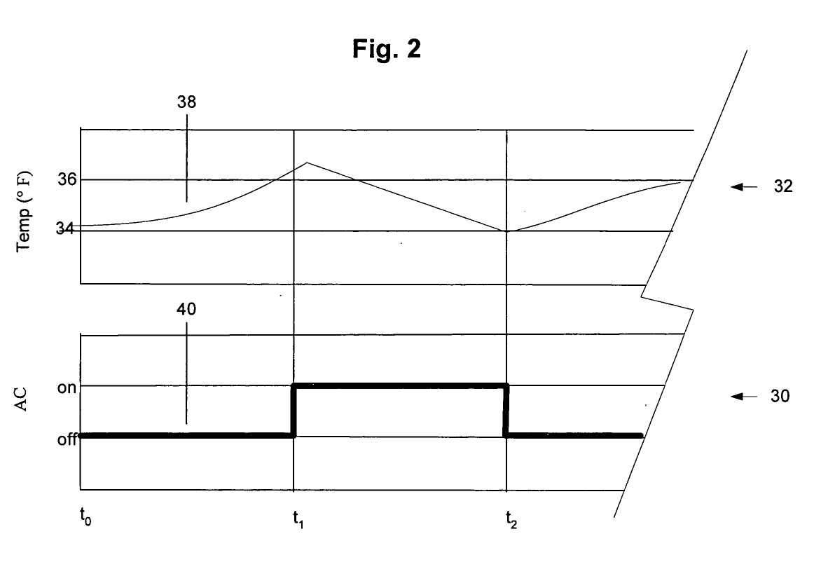

FIG. 2 shows a conventional temperature-based thermostatic control for an air conditioner, which is incorporated into the control system of the present invention. It illustrates the on-off cycling of the air conditioner function 30 in response to the temperature 32 of the interior space as measured by sensor probe 24 of sensor 22 that is operatively connected to controller 12. A temperature set point 34 is programmed or otherwise inputted to the controller 12, which constitutes the desired temperature for the interior space, and therefore the lower limit that will be permitted by control system 10 for the temperature fluctuation. For purposes of example, this preset temperature could be 72° F. The controller 12 will also include a predetermined upper limit 36 for the permitted temperature fluctuation based upon this lower limit 34. For instance, upper limit 36 might be preset at the factory to be 1° above the temperature preset (i.e., 73° F.), or the controller system 10 might permit the user directly to input or program this upper limit into control 12 in order to gain an additional measure of control.

Trace 38 shows the temperature of the interior space as measured by sensor probe 24. At time t₀, this temperature is around the preset 72° F. level, and the air conditioner is maintained in the “off” position by the controller 12, as shown by trace 40. The sensed temperature level 32 gradually increases over time due to ambient heat load, humidity level, or heat emitted by occupants within the interior space until it reaches the upper temperature limit 36 at time t₁. At this point in time, controller 12 will process this sensed temperature input to cause air conditioner 14 to be turned to its “on” position. Cool air 16 will then be introduced to interior space 18, which will gradually reduce the sensed temperature 32, as shown by trace 38. At time t₂, this sensed temperature 32 has returned once again to temperature preset 34, which causes controller 12 to turn air conditioner 14 to its “off” position, as shown by trace 40. This process will be repeated over time, whereby the control system 10 maintains the temperature 32 sensed in the interior space between the desired preset temperature 34 and the permitted upper limit 36. The air conditioner on-cycle between times t₁ and t₂ is called the “primary on-cycle” for purposes of this invention.

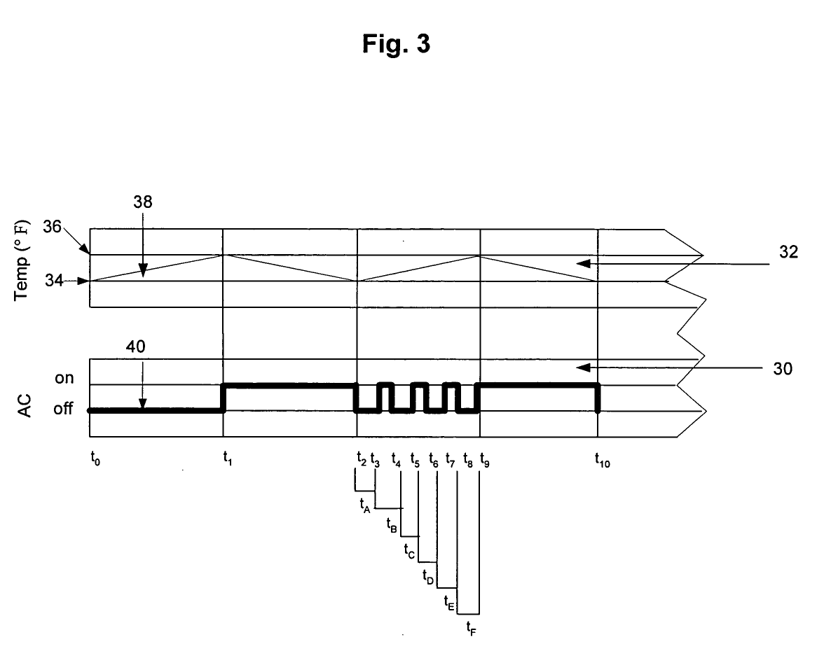

The control system 12 of the present invention also includes a timer-based secondary on-cycle or more preferably a series of such secondary on-cycles, as shown more fully in FIG. 3. Once controller 12 turns off air conditioner 14 at time t₂ to commence the primary off-cycle, sensed temperature 32 will gradually rise until it reaches the permitted upper limit 36 at time t₉, whereupon controller 12 turns on the air conditioner once again to commence another primary on-cycle. However, during the intervening primary off-cycle, after the passage of an idle cycle lasting for time t_{A} between times t₂ and t₃, controller 12 will turn the air conditioner on once again in response to on-timer 26 for a short “burst cycle” lasting for time t_{B} between times t₃ and t₄. At time t₄, controller 12 will turn off the air conditioner once again to commence another idle cycle controlled by off-timer 27 for the time interval t_{c} lasting between times t₄ and t₅. At time t₅, the controller 12 will turn on the air conditioner to commence another burst cycle lasting time t_{D} until time t₆ occurs. This process of successive idle cycles (t_{E}, etc.) and burst cycles (t_{F}, etc.) will be repeated until the controller commences the next temperature-regulated primary on-cycle for the air conditioner at times t₉.

A crucial aspect of this invention is that these burst cycles for the air conditioner are only meant to freshen the air in the interior space and reduce its humidity content without materially cooling it, which is the function of the primary on-cycle for the air conditioner. Thus, these burst cycles should be very short in duration. The required duration of the burst cycles will be influenced by a number of structural, system, and environmental factors, including the volume of the interior space; the amount and quality of insulation in the walls, roof, ceiling, and windows surrounding the interior space; the cooling or heating capacity of the HVAC system; the outdoor temperature and/or humidity levels; whether it is a sunny or cloudy day; whether shade benefits the interior space; the relative capacity of the occupants to endure uncomfortable air quality within the interior space; and the relative priority of the user between air comfort vs. economy. It is believed, however, that such burst cycles should last typically between 1 and 6 minutes, more preferably 2-5 minutes, even more preferably 2-4 minutes. Typically, the first two or three minutes of an air conditioner cycle entails a humidity reduction of the processed air without any cooling. Thus, a burst cycle of 2-4 minutes will accomplish the desire humidity reduction, while producing a very small amount of cooling of the air, compared with the air conditioner primary on-cycle which can last approximately 10 minutes for a very tightly insulated building with energy efficient windows on a temperate day. This primary on-cycle will be considerably longer in duration for such a house on a hotter day, or a less energy-efficient house.

The idle cycle duration between burst cycles is also an important part of this invention. If this idle cycle is too long, then the air will be more likely to become stagnant during primary off-cycles, because a very limited number of burst cycles, or perhaps even no burst cycle will be possible before the next primary on-cycle commences in response to the sensed temperature exceeding temperature limit 36. At the same time, if the idle cycle is too short in duration, then the repeated burst cycles that result will be more likely to cause unwanted cooling of the interior space below the preset temperature level, will consume more energy, may produce unwanted wear and tear on the air conditioner unit through excessive cycling, and may prove annoying to the occupants in the building. Such idle cycle will be impacted by the structural, system, and environmental factors discussed above. However, it is believed that the idle cycle for purposes of this invention should have a duration of 10-55 minutes, more preferably 15-45 minutes, even more preferably 15-30 minutes.

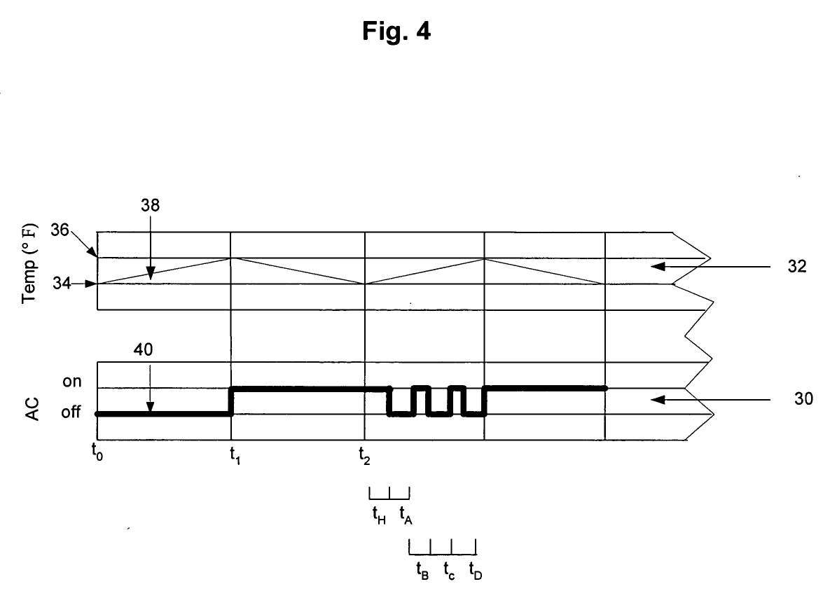

A preferred embodiment of the present invention is shown in FIG. 4. Unlike the embodiment shown in FIG. 3 where controller 12 shut off the air conditioner 14 and its blower fan at time t₂ when the sensed temperature 32 in the interior space 18 reached the preset temperature 34, the controller 12 for the FIG. 4 embodiment has been pre-programmed to leave the blower fan for the air conditioner on for an additional incremental “hold time” t_{H} before it is shut off to commence the idle cycle t_{A}. Such idle cycle t_{A} will be followed by subsequent alternating burst cycles t_{B}, t_{D}, etc. and idle cycles t_{C}, t_{E}, etc. as described above to introduce bursts of fresh air to the interior space and dehumidify the air during the primary off-cycle for the air conditioner. However, this hold time t_{H} which should be relatively short in time—e.g., 1-3 minutes—will provide the opportunity for the residual cooled air that is still in the air conditioning system plenum to be driven by the blower fan through the associated ducts to the interior space to provide maximum cooling and freshening of the air. This will enhance the energy efficiency of the air conditioning system and delay the stagnation of the air in the interior space. It is important to note that the air conditioner does not continue to operate during this hold time t_{H}. Because of this continued introduction of the residual air-conditioned air to the interior space during the hold time t_{H}, it may be possible for the idle cycles of the secondary air conditioning on-cycles to be longer relative to the burst cycles, or for the controller to be programmed to produce fewer burst cycles during the primary air conditioner off-cycle.

As mentioned above, the user interface 28 allows the user to program a number of functionalities for control system 10. In addition to inputting the desired preset temperature 34, there is an on/off control that permits the user to turn on the secondary on-cycle mode for bursts of air-conditioned air, or alternatively to shut off this mode so that the air conditioner is operated in a conventional mode with temperature-based primary on-cycle alone. Provision is also made in the user interface for inputting of the duration of the idle cycles and burst cycles for the secondary air conditioning mode. The durations for such alternating idle cycles and burst cycles will determine how many burst cycles occur within the time span of the primary off-cycle before sensor 22 detects the temperature of the interior space to be above the limit 36 to cause the controller to turn on the air conditioner for a primary on-cycle. Alternatively, the controller could be designed to allow the user to program the number of burst cycles and duration of the idle or burst cycle with the controller automatically calculating the missing burst or idle cycle duration value.

It is important to note that the purpose of the secondary air conditioning mode is to enhance the comfort quality of the interior space 18, and not to cool it, per se, or particularly to overcool it. Therefore, an important feature of the control system 10 is that it will cause the controller 12 to automatically shut down the secondary air conditioning mode if the sensor 22 detects that the temperature 32 in the interior space has fallen more than a permitted temperature increment below the preset temperature 34. This permitted temperature increment should be fairly small in order not to impede the efficiency of the primary air conditioning mode for cooling the interior space air—e.g., 1° F. or 1° C.

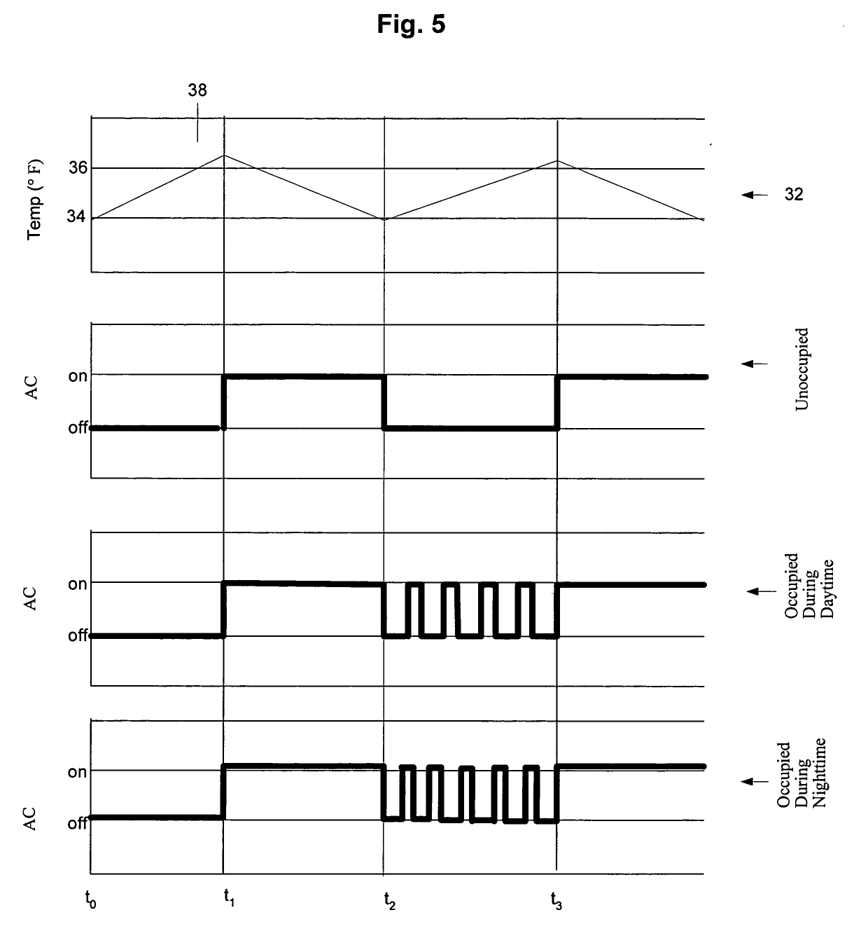

In a further preferred embodiment of the present invention, the user interface permits the user to input or program different time periods of the day or night when the need for the secondary air conditioning mode for introducing fresh air to the interior space may be higher or lower. For instance, during the day when no one is at home and the interior space is unoccupied, there may be no need for this secondary air conditioning mode, so it can be shut off by the controller. On the other hand, during the evening hours when family members are at home, it may be desirable to have the secondary air conditioning mode on to introduce bursts of fresh air to the interior space to enhance its comfort quality. During the night hours when stagnant air can be most problematic, this secondary air conditioning mode could not only be programmed for the “on” position, but also the controller could be programmed to produce more burst cycles during the primary off-cycle of the air conditioner (e.g., shorter idle cycles and/or longer burst cycles) compared with the settings programmed for other times of the day. FIG. 5 illustrates this concept of programmability for unoccupied vs. occupied times.

Still another possible embodiment of the present invention is provided by an “Insta-burst” version of the secondary burst cycles. In this embodiment, the user interface 28 of the controller 12 may be designed to enable the user to request an immediate burst cycle of the air conditioner in response to a particularly uncomfortable condition of the air in the interior space. Upon pressing a button on the interface control panel to cause the controller to produce such a burst cycle, the air conditioner will operate during such a burst cycle. Upon the completion of the burst cycle, the controller will commence a new idle cycle if the burst cycle mode was turned on when the Insta-burst feature was activated by the user. If the burst cycle mode was turned off, however, then a primary off-cycle would commence upon completion of this Insta-burst cycle. It should be appreciated that this Insta-burst feature could be designed into the thermostatic control of the present invention to supplement the programmed series of supplemental burst cycles, or be programmed or designed in lieu of such series of burst cycles feature. The secondary air conditioning mode for providing burst cycles of fresh air under this invention has a number of possible end-use applications. A primary application is for residences where the homeowner wants to establish higher levels of air comfort quality during evening and night hours, temperate daytime hours, or seasonally where humidity can be more of a problem (e.g., in the Summer). However, it also has many applications in the commercial realm where the need for a high level of air comfort quality is important for worker productivity or customer satisfaction. This includes office buildings, factories, hospitals, laboratories, shopping malls and retail stores, schools, government buildings, museums, gyms and exercise facilities, arenas and other entertainment venues, and a host of other commercial establishments. Programmability for different time zones is particularly important for such commercial applications when there may be less of a need for the burst cycles of fresh air during weekends, nights, or holidays than for the business week during operating hours. In a business environment where air conditioning is controlled centrally, or in a centrally-controlled, multi-tenant environment, the control system 10 can allow individual control for on/off modes, as well as different timing parameters and functions at the zonal level for different tenants or rooms within the commercial interior space.

In the case of hospitals, the control system of the present invention could provide centralized control down to the room level. This would provide maximum air comfort quality for all of the varied needs within the hospital environment, whether it is a patient room, cafeteria, or surgical operating room. The burst cycles provided by the secondary air conditioning mode of the present invention could also be ideal for clean rooms at research or manufacturing facilities where workers often wear specialized, sterile garments that do not breathe particularly well.

This invention may also have many applications within the transportation industry. Automobile air conditioning systems suffer from the same problems as residential and commercial applications where air can become stagnant during prolonged off-cycles regulated by temperature-based control systems. The opportunity to introduce burst cycles of fresh air to the automobile, SUV, or truck cabin may provide welcome relief to the driver and passengers alike. At the same time, because the additional draw on the air conditioning system is minimal for these secondary burst cycles, fuel efficiency will not be compromised. Because the compressor duty imposed by air conditioning systems can cause a transitory reduction in engine power, it may be helpful to design the improved thermostatic control of this invention to temporarily stop a burst cycle while the transportation vehicle is accelerating above a predetermined threshold. This invention could also have useful applications for mass transit environments like airplanes, trains, and buses where many passengers are crowded into a small space. More burst cycles might be needed compared with building environments due to the smaller spaces involved for automobiles, SUVs, trucks, airplanes, trains, and buses, so the preferred duration of the idle cycle might be smaller on the order of three minutes.

The secondary burst cycle feature incorporated into the thermostatic control of the present invention is useful for providing fresh, conditioned air to an interior space when the ambient conditions are insufficient to trigger HVAC system activation (e.g., evenings, nights, cloudy days, higher humidity levels on cooler days). These programmed or manually-induced burst cycles may also serve to even out the temperature swings within the interior space to produce a condition of homeostasis. Because the time required for the sensed temperature to reach the permitted limit is delayed, such burst cycles may cause the HVAC system to run in a more energy-efficient manner, since the primary HVAC on-cycle will be shorter or less frequent relative to the primary off-cycles.

Another potential benefit of this invention may arise from the general difference in temperatures perceived by different occupants. Whether due to differing circulation systems, iron levels, or other causes, some individuals seem to feel colder in response to a temperature condition than other individuals do. This can cause one occupant in a building or transportation vehicle to wish to set the temperature preset higher for a heater (i.e., to heat the interior space to a greater degree), or set the temperature preset higher for an air conditioner (i.e., to cool the interior space to a lesser degree) than the level desired by another occupant. This proverbial “Battle of the Thermostat” can be ameliorated by the thermostat control of the present invention, since the burst cycles of fresh, conditioned air may enable the occupant desiring the lower temperature present more easily to tolerate a higher temperature preset without undue discomfort.

The burst cycles of the thermostatic control of the present invention can provide still another benefit to allergy sufferers. Excessive allergen conditions in the Spring and Fall typically cause allergy sufferers to want to close the windows and doors of their homes. In more temperate regions where air conditioners run less often, this can lead to stale and sweltering air within the interior space. The secondary burst cycles of the air conditioner will help to overcome these uncomfortable conditions. At the same time, the burst cycles of fresh air may also reduce the moisture levels in tightly insulated buildings that can otherwise cause molds—a common allergen. These benefits to allergy sufferers will be even greater if the air conditioned air produced during the burst cycles is run through a HEPA filter or other air purification system to remove allergen particulates.

The above specification, drawings, and data provide a complete description of the structure and design of the present invention. Since many embodiments of the invention can be made without departing from the spirit and scope of the invention, the invention resides in the claims hereinafter appended.

I claim:

1. A method for controlling an HVAC system for delivering conditioned air to an interior space, such method comprising the steps of:
(a) identifying a temperature set point for the interior space;
(b) determining whether the temperature of the interior space has risen above or below a predetermined upper or lower temperature limit;
(c) commencing a primary on-cycle for operation of the HVAC unit when the temperature meets the predetermined temperature limit until the temperature returns to the temperature set point to cease operation of the HVAC unit and commence a primary off-cycle for the HVAC unit;
(d) commencing an idle cycle for a first time period during the primary off-cycle;
(e) commencing a burst cycle for a second time period upon completion of the idle cycle during which the HVAC is operated to provide conditioned air to the interior space to improve its comfort quality;
(f) repeating steps (d) and (e) sequentially until the termination of the primary off-cycle and commencement of the next primary on-cycle;
(g) determining whether the temperature of the interior space exceeds a predetermined increment beyond the predetermined temperature limit during the burst cycle in which case the burst cycle is promptly terminated; and
(h) wherein the second time period is shorter than the first time period.

2. The method of claim 1, wherein the HVAC system is an air conditioner.

3. The method of claim 1, wherein the HVAC system is a furnace.

4. The method of claim 3 further comprising a humidifier operatively connected to the furnace, wherein the humidifier is operated when the furnace operates to deliver moisture to the air conditioned by the furnace.

5. The method of claim 1 further comprising an air exchanger operatively connected to the HVAC system, wherein the air exchanger is operated when the HVAC system operates to deliver fresh outdoor air to the HVAC system for conditioning.

6. The method of claim 1, wherein the first time period is 10-55 minutes.

7. The method of claim 6, wherein the first time period is 15-45 minutes.

8. The method of claim 6, wherein the first time period is 15-30 minutes.

9. The method of claim 1, wherein the second time period is 1-6 minutes.

10. The method of claim 9, wherein the second time period is 2-5 minutes.

11. The method of claim 9, wherein the second time period is 2-4 minutes.

12. The method of claim 1, wherein the comfort quality characteristic of the air is reduced humidity, increased humidity, or increased freshness.

13. The method of claim 1, wherein the interior space is contained in a building or a transportation means.

14. The method of claim 13, wherein the building is selected from the group consisting of a house, apartment, condominium, hotel, office building, factory, shopping mall or retail establishment, restaurant, hospital, laboratory, arena or entertainment establishment, gym or fitness facility, museum, school or university, government office or public facility.

15. The method of claim 13, wherein the transportation vehicle is selected from the group consisting of an automobile, truck, airplane, train, or bus.

16. The method of claim 1 further comprising a user-activated immediate burst cycle initiated during a primary off-cycle and lasting for the second time period, followed by the commencement of an idle cycle under step (d).

17. The method of claim 1 further comprising:
(a) identifying whether the interior space is expected to be occupied or unoccupied;
(b) increasing the first time period for the idle cycle relative to the second time period for the burst cycle if the interior space is expected to be unoccupied; and
(c) decreasing the first time period for the idle cycle relative to the second time period for the burst cycle if the interior space is expected to be occupied.

18. The method of claim 1 further comprising:
(a) identifying the time of day; and
(b) decreasing the first time period for the idle cycle relative to the second time period for the burst cycle when the time of day is nighttime.

19. The method of claim 1, wherein the predetermined temperature increment is 1° F. or 1° C.

20. A system for controlling an HVAC system that is adapted to service an interior space, the system comprising:
(a) means for storing a temperature set point for the interior space, a predetermined temperature threshold limit, an idle cycle time period, and a burst cycle time period;
(b) one or more sensors for determining the temperature level within the interior space;
(c) means for determining if the temperature level of the interior space has risen above or below the predetermined temperature limits;
(d) means for commencing a primary on-cycle for operation of the HVAC unit when the temperature meets the predetermined temperature limit until the temperature returns to the temperature set point to commence a primary off-cycle for the HVAC unit;
(e) means for commencing an idle cycle for its predetermined time period during the primary off-cycle;
(f) means for commencing a burst cycle for its predetermined time period upon completion of the idle cycle during which the HVAC unit is operated to provide conditioned air to the interior space to improve its comfort quality;
(g) means for repeating the idle cycles and burst cycles sequentially until the termination of the primary off-cycle, and commencement of the next primary on-cycle;
(h) means for determining whether the temperature of the interior space exceeds a predetermined increment beyond the predetermined temperature limit during a burst cycle in which case the burst cycle is promptly terminated; and
(i) wherein the second time period is shorter than the first time period.

21. The system of claim 20, wherein the HVAC system is an air conditioner.

22. The system of claim 20, wherein the HVAC system is a furnace.

23. The system of claim 22 further comprising a humidifier operatively connected to the furnace, wherein the humidifier is operated when the furnace operates to deliver moisture to the air conditioned by the furnace.

24. The system of claim 20 further comprising an air exchanger operatively connected to the HVAC system, wherein the air exchanger is operated when the HVAC system operates to deliver fresh outdoor air to the HVAC system for conditioning.

25. The system of claim 20, wherein the first time period is 10-55 minutes.

26. The system of claim 25, wherein the first time period is 15-45 minutes.

27. The system of claim 25, wherein the first time period is 15-30 minutes.

28. The system of claim 20, wherein the second time period is 1-6 minutes.

29. The system of claim 28, wherein the second time period is 2-5 minutes.

30. The system of claim 28, wherein the second time period is 2-4 minutes.

31. The system of claim 20, wherein the comfort quality characteristic of the air is reduced humidity, increased humidity, or increased freshness.

32. The system of claim 20, wherein the interior space is contained in a building or a transportation means.

33. The system of claim 32, wherein the building is selected from the group consisting of a house, apartment, condominium, hotel, office building, factory, shopping mall or retail establishment, restaurant, hospital, laboratory, arena or entertainment establishment, gym or fitness facility, museum, school or university, government office or public facility.

34. The system of claim 32, wherein the transportation vehicle is selected from the group consisting of an automobile, truck, airplane, train, or bus.

35. The system of claim 20 further comprising a user-activated immediate burst cycle initiated during a primary off-cycle and lasting for the second time period, followed by the commencement of an idle cycle under step (f).

36. The system of claim 20 further comprising:
(a) means for identifying whether the interior space is expected to be occupied or unoccupied;
(b) means for increasing the first time period for the idle cycle relative to the second time period for the burst cycle if the interior space is expected to be unoccupied; and
(c) means for decreasing the first time period for the idle cycle relative to the second time period for the burst cycle if the interior space is expected to be occupied.

37. The system of claim 20 further comprising:
(a) means for identifying the time of day; and
(b) means for decreasing the first time period for the idle cycle relative to the second time period for the burst cycle when the time of day is nighttime.

38. The system of claim 20, wherein the predetermined temperature increment is 1° F. or 1° C.

39. A system for controlling an HVAC system that is adapted to service an interior space, the system comprising:
(a) means for storing a temperature set point for the interior space, a predetermined temperature threshold limit, and a burst cycle time period;
(b) one or more sensors for determining the temperature level within the interior space;
(c) means for determining if the temperature level of the interior space has risen above or below the predetermined temperature limit;
(d) means for commencing a primary on-cycle for operation of the HVAC unit when the temperature meets the predetermined temperature limit until the temperature returns to the temperature set point to commence a primary off-cycle for the HVAC unit;
(e) user-activated means for commencing an immediate burst cycle during a primary off-cycle and lasting for its predetermined burst cycle time period during which the HVAC unit is operated to provide conditioned air to the interior space to improve its comfort quality, followed by commencement of a primary off-cycle; and
(f) means for determining whether the temperature of the interior space exceeds a predetermined increment beyond the predetermined temperature limit during the burst cycle in which case the burst cycle is promptly terminated.
